(19) United States
(12) Patent Application Publication
(10) Pub. No.: US 2018/0035475 A1
(43) Pub. Date: Feb. 1, 2018

(54) DOOR OPERATOR WITH A WIRELESS SETUP FUNCTION AND A METHOD FOR ESTABLISHING A WIRELESS COMMUNICATION OF THE DOOR OPERATOR

(71) Applicant: Chung-Hsien Hsieh, New Taipei City (TW)

(72) Inventor: Chung-Hsien Hsieh, New Taipei City (TW)

(21) Appl. No.: 15/292,204

(22) Filed: Oct. 13, 2016

(30) Foreign Application Priority Data
Jul. 27, 2016 (TW) 105123660

(51) Int. Cl. H04W 76/02; H04W 4/00

(52) U.S. Cl. CPC H04W 76/02; H04W 4/008

(57) ABSTRACT

This invention provides a door operator with a wireless setup function and a method for establishing a wireless communication of the door operator, including a wall-mounted device and an operator unit, wherein the wall-mounted device includes a setting switch, a microcontroller, a wireless transmission module and a memory unit; when the setting switch activates the wireless transmission module and is in connection with the external electronic device, the wireless transmission module receives setup information transmitted from the external electronic device in a wireless communication mode, and the microcontroller stores the setup information in the memory unit, and the operator unit is activated in accordance with the setup information. A user may configure/alter the various functions of the door operator easily. As the setting switch has to be turned on before commencing the setup, it prohibits unauthorized access to the door operator, and improves the security of the door operator.

### FIELD OF THE INVENTION

The present invention relates to a door operator with a wireless setup function and a method for establishing a wireless communication of the door operator, particularly to a door operator that is cooperative with an external electronic device, such as a smartphone, a tablet computer, a notebook computer and/or a wearable electronic device for configuring various functions of the door operator, and the method for establishing the wireless setup.

### BACKGROUND OF THE INVENTION

During the installation of the conventional door operators, setups are normally configured according to the surrounding and the owner's requirements. The setups include door operator position setup for setting the upper and lower limit positions of the movable barrier, automatic door opening/closing setup for setting the opening or closing time, reverse control setup for setting the reverse of the door movement when the movable barrier encounters an obstacle; and time setup for setting the time such as date and real-time clock and so forth.

However, setup alteration is very difficult once installation and configuration are completed. This is because a door operator is usually installed at a high location, and a ladder or an elevating device has to be used in order to access the door operator in case setups have to be reconfigured. Even more, decoration may have to be dismantled in order to access the door operator. Moreover, dedicated configuration equipment or software is usually used for different brands of door operators normally are equipped with exclusive installations or softwares, and so the engineers from the original vendor are needed to conduct the configuration. The owners will not be able to configure the setups by themselves.

As the door operator involves access control, high security is needed. If the user is allowed for direct configuration through on-line setting, the security of the access control would be compromised.

### SUMMARY OF THE INVENTION

The main objective of the present invention is to provide a door operator with a wireless setup function and a method for establishing a wireless communication of the door operator, which enable the user to configure various functions of the door operator on his own, thereby improving security level. Only the user is allowed to establish the connection, and connection from outside by others is precluded.

To achieve the above objective, it is provided a door operator with a wireless setup function comprising essentially a wall-mounted device and an operator unit, wherein the wall-mounted device comprises a setting switch, a microcontroller, a wireless transmission module and a memory unit; and the setting switch, the wireless transmission module and the memory unit are electrically connected to the microcontroller. The setting switch is configured to activate or deactivate the wireless transmission module for establishing a connection with an external electronic device or interrupting the connection from the external electronic device. In addition, the operator unit is coupled electrically to the wall-mounted device. When the setting switch activates the wireless transmission module to establish a connection with the external electronic device, the wireless transmission module receives setup information transmitted from the external electronic device in a wireless communication mode, while the microcontroller is adapted to store the setup information in the memory unit, and to control the activation of the operator unit in accordance with the stored setup information.

Accordingly, the present invention allows the user to configure or alter various functions of the door operator easily, thereby overcome the afore-mentioned drawbacks as found in existing art. Moreover, in the present invention, the setting switch has to be turned on before the setup to establish a connection between the external electronic device and the wireless transmission module. By such approach, a further security control is provided to prohibit unauthorized access to the door operator. The security of the door operator can be improved significantly.

The operator unit and the wall-mounted device are not restricted to the afore-mentioned arrangement. According to a further aspect of the present invention, the microcontroller, the wireless transmission module and the memory unit may be provided in the operator unit, and only the setting switch is provided in the wall-mounted device.

Preferably, the setting switch may be a button switch, an audio switch, a near field communication (NFC) module, a radio frequency identification (RFID), an infrared module, a fingerprint recognition switch, and/or other equivalent module capable of controlling activation or deactivation of an electronic module.

The wireless transmission module may be a Bluetooth module, a Zigbee module, a wireless radio frequency (RF) module, a wireless fidelity (Wi-Fi) module, a near field communication (NFC) module, an ultra high frequency (UHF) radio module, a worldwide interoperability for microwave access (WiMAX) module, a general packet radio service (GPRS) module, a 3rd-generation (3G) module, a 3.5th generation (3.5G) module, a long term evolution (LTE) module, and/or other equivalent module of wireless communication.

The wireless communication mode may be an infrared transmission mode, a Bluetooth transmission mode, a radio frequency transmission mode, a near field communication transmission mode, a wireless fidelity (Wi-Fi) transmission mode, a Zigbee transmission mode, an ultra high frequency (UHF) radio transmission mode, an internet transmission mode, an Email mode, a browser interaction mode, an instant messaging mode, a phone short message mode, and/or other equivalent mode of wireless communication.

The wall-mounted device may further comprise an identity recognition module electrically connected to the microcontroller; and the identity recognition module may be a fingerprint recognition device, a password input device, a voiceprint recognition device, a face recognition device, an iris recognition device, and/or other equivalent device capable of recognizing identity of the user. Therefore, the present invention may identify the identity of the user to determine whether or not the user is allowed to login for configuration. Moreover, the authorization level of the user for configuration may be determined. That is, the extent of configuration or alteration that the user may make is determined.

To achieve the above objective, the present invention provides a method for establishing a wireless communication of a door operator having a wall-mounted device and an operator unit electrically connected therewith. The method comprising the steps of: activating a wireless transmission function of the wall-mounted device for the connection of an external electronic device; receiving setup information transmitted from the external electronic device; and allowing the operator unit to activate in accordance with the setup information.

Preferably, in the step of activating the wireless transmission function, the wall-mounted device activates or deactivates the wireless transmission function through a setting switch; and the setting switch may be a button switch, an audio switch, a near field communication (NFC) module, an infrared module, and/or other equivalent modules capable of activating or deactivating an electronic module in a controlled manner.

In the step of receiving the setup information transmitted from the external electronic device, the wall-mounted device receives the setup information in a wireless communication mode; and the wireless communication mode may be an infrared transmission mode, a Bluetooth transmission mode, a radio frequency transmission mode, a near field communication transmission mode, a wireless fidelity (Wi-Fi) transmission mode, a Zigbee transmission mode, an ultra high frequency (UHF) radio transmission mode, an internet transmission mode, an Email mode, a browser interaction mode, an instant messaging mode, a phone short message mode, and/or the equivalents.

Additionally, after the step of activating the wireless transmission function and before the step of receiving the setup information transmitted from the external electronic device, the present invention further provides a step of identifying a user holding the external electronic device; wherein the identification mode may be fingerprint identification, password identification, voiceprint identification, face identification, iris identification, and/or the equivalents.

Moreover, after the step of receiving the setup information transmitted from the external electronic device, the present invention may further provide a step, in which the wall-mounted device may interrupt the connection with the external electronic device automatically after the wall-mounted device has received the setup information. In other words, after the setup information has been transmitted, the wall-mounted device interrupts the connection and turns off the wireless transmission function automatically, such that no unauthorized external device is allowed to connect to the wall-mounted device for any setup alteration. Therefore, the security level is improved further.

### BRIEF DESCRIPTION OF THE DRAWINGS

FIG. 1 is a schematic view of a preferred embodiment according to the present invention.

FIG. 2 is a system architecture diagram of a preferred embodiment according to the present invention.

FIG. 3 is a configuration flowchart of a preferred embodiment according to the present invention.

### DESCRIPTION OF THE PREFERRED EMBODIMENT

In the description which follows, like parts are marked throughout the specification and drawing with the same reference numerals. The drawing figures are not necessarily to scale, and certain features may be shown in somewhat generalized or schematic form in the interest of clarity and conciseness.

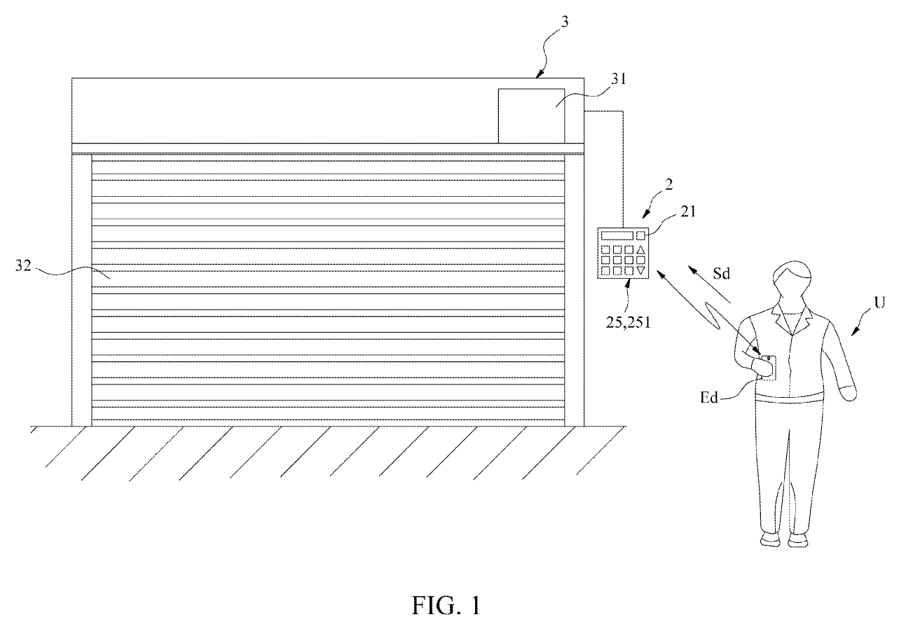

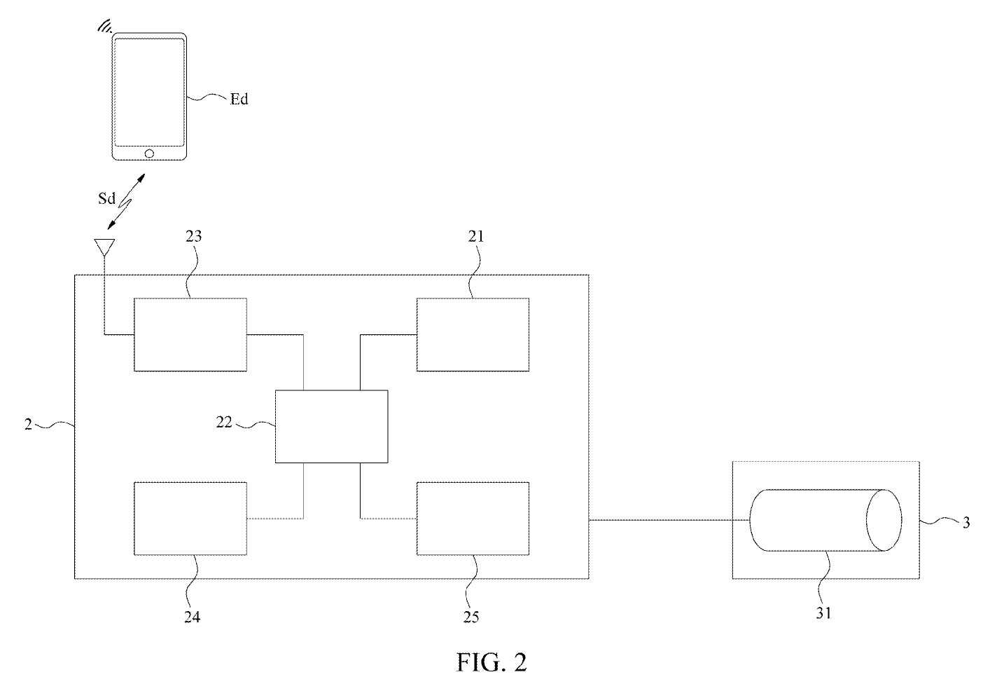

Referring to FIGS. 1 and 2, FIG. 1 is a schematic view of a preferred embodiment according to the present invention, and FIG. 2 is a system architecture diagram of a preferred embodiment according to the present invention. As shown in the figures, the door operator with wireless setup function comprises a wall-mounted device 2 and an operator unit 3. The operator unit 3 comprises a movable barrier 32 and an electric motor 31 which may move the movable barrier 32 in a controlled manner. The wall-mounted device 2 is disposed on a wall in proximity to the movable barrier 32 where a user may reach.

The wall-mounted device 2 comprises a setting switch 21, a microcontroller 22, a wireless transmission module 23, a memory unit 24 and an identity recognition module 25. The setting switch 21, the wireless transmission module 23, the memory unit 24 and the identity recognition module 25 are electrically connected to the microcontroller 22. Although in this embodiment, the microcontroller 22, the wireless transmission module 23 and the memory unit 24 are provided in the wall-mounted device 2, these components may also be provided in the operator unit 3. In other words, the microcontroller 22, the wireless transmission module 23 and the memory unit 24 may either be provided in the wall-mounted device 2 or in the operator unit 3, as the case may be.

The setting switch 21 is intended to activate the wireless transmission module 23 for an external electronic device Ed to connect, or to deactivate the wireless transmission module 23 for interrupting the connection. The setting switch 21 may be a button switch, an audio switch, a near field communication (NFC) module, a radio frequency identification (RFID), an infrared module, or the equivalents. In this embodiment, as shown in FIG. 1, a general button switch, such as the physical key provided on a control panel of the wall-mounted device 2 is used.

It is noted particularly that the wall-mounted device 2 is provided inside a building, so that only a person inside the building can operate the control panel of the wall-mounted device 2. In other words, those outside the building do not have access to the setting switch 21 arranged on the control panel of the wall-mounted device 2 to activate the connection. In this way, the persons to perform configuration or alteration can be preliminarily selected. The external electronic device Ed may be a smartphone, a tablet computer, a notebook computer or a dedicated equipment. A general smartphone with a dedicated application program (APP) installed therein is used in the embodiment.

The microcontroller 22 is used essentially to control the activation of various electronic components. The wireless transmission module 23 is responsible for connecting with the external electronic device Ed, and transmitting or receiving data packets. The wireless transmission module may be a communication module that is accorded with any wireless communication protocol on the market, or any particular protocol for exclusive use. In this embodiment, a Bluetooth communication module is used as the wireless transmission module 23.

The memory unit 24 is used essentially to store various setup information and user authorization data. It may be a fixed or movable random access memory (RAM), read-only memory (ROM), Flash memory, hard disk or other similar device, or a combination of the above.

The identity recognition module 25 is electrically connected to the microcontroller 22, and is intended to recognize the identity of the user. It may be a fingerprint recognition device, a password input device, a voiceprint recognition device, a face recognition device, an iris recognition device or the equivalents. In this embodiment, the identity recognition module 25 is a password input device 251, which is a number or letter keyboard with physical keys. In other words, the user has to input a password through the password input device 251 to acquire authorization.

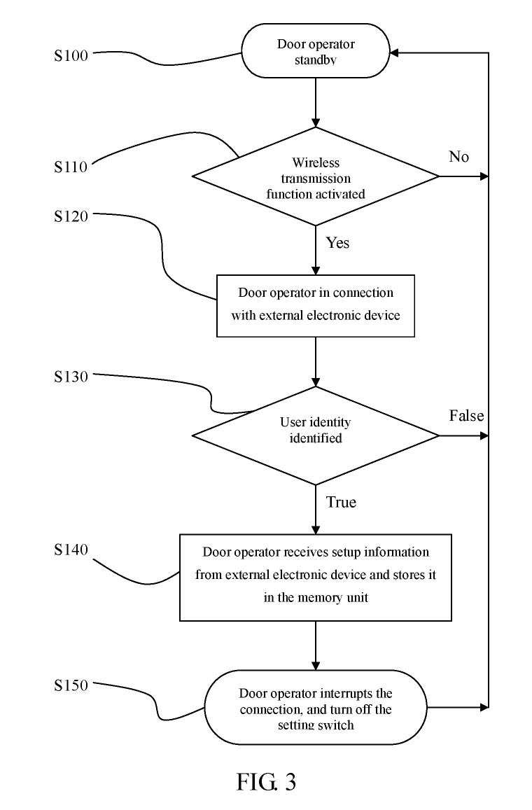

Referring now to FIG. 3, which is a configuration flowchart of a preferred embodiment according to the present invention. In the description that follows, the configuration or setup procedures according to this embodiment is explained. At first, the door operator is in an activated standby state, as shown by step S100 in FIG. 3. Then, a user U operates the setting switch 21 on the control panel of the wall-mounted device 2, and in turn, the microcontroller 22 controllably activates the wireless transmission function of the wireless transmission module 23 so that an external electronic device Ed may establish connection, as shown by step S110 in FIG. 3.

Furthermore, the external electronic device Ed is connected with the wireless transmission module 23 of the door operator, as shown by step S120 in FIG. 3. Then, the step of recognizing identity of the user is performed. The user holding the external electronic device Ed is requested to input a password so that his identity may be identified, as shown by step S130 in FIG. 3.

Once the user passes the identity identification, the external electronic device Ed will transmit setup information Sd to the wireless transmission module 23 in a wireless communication mode, and the microcontroller 22 controls the wireless transmission module 23 to receive the setup information Sd and store the same in the memory unit 24, as shown by step S140 in FIG. 3.

According to the embodiment, the setup information Sd includes door operator position setup, upper and lower limit position setup of the movable barrier; interaction setup, inching setup, setup about whether or not door opening/closing actions are continuous; time setup, date and real-time clock setup; battery control setup, self-test time setup for battery; power alert setup, alert setup for primary or backup power failure; clutch control setup, clutch lockup time setup; automatic door opening/closing setup, time setup for opening or closing door; reverse control setup, time setup for reversing the electric motor as an obstacle is encountered; delay time setup, time setup for central control delay or high temperature alert delay etc.

Moreover, as the dedicated application program (APP) is installed in the external electronic device Ed in advance, the user may utilize the application program directly and instantaneously to configure or seet up the door operator. However, in other embodiments, the user may also activate the application program at first and pre-store setup values. After the user passes identity identification, the external electronic device Ed transmits the pre-stored setup value to the door operator immediately. Such a configuration mode is applicable particularly to a model in which the same setup parameter is used to configure multiple door operators. For example, in a field where multiple door operators are installed, the user may simply establish connection with each of the door operators in sequence, and the configuring/set up profiles will be uploaded automatically. The operation is convenient. The communication mode of such model may be a near field communication (NFC) module.

Moreover, after the wall-mounted device 2 has received the setup information Sd, the wall-mounted device 2 interrupts the connection with the external electronic device Ed automatically and deactivates the wireless transmission module 23, as shown by step S150 in FIG. 3. In this embodiment, it may be configured such that the microcontroller 22 will deactivate the wireless transmission module 23 in a controlled manner 5 seconds later after the setup information Sd has been received, in order to prevent unauthorized external devices from establishing connection with the wall-mounted device 2 for setup alteration or configuration. Therefore, security is improved further. Subsequently, the operator unit 3 will operate in accordance with the setup information Sd.

To sum up, the present invention has at least the following advantages:

1. Users are allowed to configure setup parameters by themselves. The setup or configuring restrictions that existing door operator faces due to the location of the door operation and the need for vendor engineers are eliminated. The user may utilize a smartphone to configure or alter the setup of the door operator whenever needed;

2. Risk of external intrusion is eliminated. The setting switch 21 (physical key or the equivalents) has to be used at first to turn on the wireless transmission function of the door operator. As such, unauthorized persons cannot establish connection with the door operator for setup alteration arbitrarily, and thus security is improved significantly;

3. Not only real-time configuration may be performed by an external electronic device Ed for the door operator, but also a pre-stored setup information Sd may be transmitted to the door operator automatically for configuration after the external device has connected with the door operator, so that configuration of multiple door operators may be performed more rapidly and conveniently;

4. After the wall-mounted device 2 has received the setup information Sd, the wall-mounted device 2 interrupts the connection with the external electronic device Ed automatically and deactivates the wireless transmission module 23, in order to prevent other unauthorized external devices from connecting to the wall-mounted device for setup alteration. Therefore, security is improved further.

While the invention has been illustrated and described in connection with an example of a roller door, it is not intended to be limited to the details as shown. The invention may be embodied in various doors such as accordion doors, horizontal doors, folding doors or the like.

While the preferred embodiments have been described as above, it is to be noted that the description and accompanying drawings disclosed herein are not intend to restrict the scope of implementation of the present invention. Variations and modifications equivalent to the above embodiments and able to be realized are considered to be within the scope of the present invention.

What is claimed is:

1. A door operator with a wireless setup function, comprising:
a wall-mounted device comprising a setting switch, a microcontroller, a wireless transmission module and a memory unit; the setting switch, the wireless transmission module and the memory unit being electrically connected to the microcontroller; the setting switch being configured to activate or deactivate the wireless transmission module for establishing a connection with an external electronic device or interrupting the connection from the external electronic device; and
an operator unit coupled electrically to the wall-mounted device;
wherein when the setting switch activates the wireless transmission module to establish a connection with the external electronic device, the wireless transmission module receives setup information transmitted from the external electronic device in a wireless communication mode, the microcontroller being adapted to store the setup information in the memory unit, and to control the activation of the operator unit in accordance with the stored setup information.

2. The door operator as claimed in claim 1, wherein the setting switch is composed of at least one device selected from the group consisting of a button switch, an audio switch, a near field communication (NFC) module, a radio frequency identification (RFID) and an infrared module.

3. The door operator as claimed in claim 1, wherein the wireless transmission module is composed of at least one module selected from the group consisting of a Bluetooth module, a Zigbee module, a wireless radio frequency (RF) module, a wireless fidelity (Wi-Fi) module, a near field communication (NFC) module, an ultra high frequency (UHF) radio module, a worldwide interoperability for microwave access (WiMAX) module, general packet radio service (GPRS) module, a 3rd-generation (3G) module, a 3.5th generation (3.5G) module and a long term evolution (LTE) module.

4. The door operator as claimed in claim 1, wherein the wireless communication mode is composed of at least one mode selected from the group consisting of an infrared transmission mode, a Bluetooth transmission mode, a radio frequency transmission mode, a near field communication transmission mode, a wireless fidelity (Wi-Fi) transmission mode, a Zigbee transmission mode, an ultra high frequency (UHF) radio transmission mode, an internet transmission mode, an Email mode, a browser interaction mode, an instant messaging mode and a phone short message mode.

5. The door operator as claimed in claim 1, wherein the wall-mounted device further comprises an identity recognition module electrically connected to the microcontroller; the identity recognition module is composed of at least one device selected from the group consisting of a fingerprint recognition device, a password input device, a voiceprint recognition device, a face recognition device and an iris recognition device.

6. A method for establishing a wireless communication of a door operator having a wall-mounted device and an operator unit electrically connected therewith, the method comprising the steps of:
(A) activating a wireless transmission function of the wall-mounted device for the connection of an external electronic device;
(B) receiving setup information transmitted from the external electronic device; and
(C) allowing the operator unit to activate in accordance with the setup information.

7. The method as claimed in claim 6, wherein in step (A), the wireless transmission function of the wall-mounted device is activated through an setting switch; the setting switch is composed of at least one device selected from the group consisting of a button switch, an audio switch, a near field communication (NFC) module and an infrared module.

8. The method as claimed in claim 6, wherein in step (B), the wall-mounted device receives the setup information in a wireless communication mode; the communication mode is composed of at least one mode selected from the group consisting of an infrared transmission mode, a Bluetooth transmission mode, a radio frequency transmission mode, a near field communication transmission mode, a wireless fidelity (Wi-Fi) transmission mode, a Zigbee transmission mode, an ultra high frequency (UHF) radio transmission mode, an internet transmission mode, an Email mode, a browser interaction mode, an instant messaging mode and a phone short message mode.

9. The method as claimed in claim 6, further comprising a step (A1) in between step (A) and step (B), wherein step (A1) comprises the step of identifying a user holding the external electronic device; the identification mode is composed of at least one mode selected from the group consisting fingerprint identification, password identification, voiceprint identification, face identification and iris identification.

10. The method as claimed in claim 6, further comprising a step (B1) in between step (B) and step (C), wherein in step (B1), the wall-mounted device interrupts the connection with the external electronic device automatically and turns off the wireless transmission function after the wall-mounted device has received the setup information.
